(19) United States
(12) Patent Application Publication
(10) Pub. No.: US 2017/0046771 A1
(43) Pub. Date: Feb. 16, 2017

(54) System and Method for Real-Time Full-Service Shopping

(71) Applicant: Arthur L. Cropp, JR., Summerville, SC (US)

(72) Inventor: Arthur L. Cropp, JR., Summerville, SC (US)

(21) Appl. No.: 15/285,964

(22) Filed: Oct. 5, 2016

Related U.S. Application Data
(60) Provisional application No. 62/203,491, filed on Aug. 11, 2015.

(51) Int. Cl. G06Q 30/06

(52) U.S. Cl. CPC G06Q 30/0633; G06Q 30/0639

(57) ABSTRACT

A mobile application for full-service grocery shopping assists users when grocery shopping. The mobile application may be downloaded on the user's mobile electronic device, enabling the user to subscribe to a grocery shopping support service, and provides access to an online database of detailed floor plans and inventories of grocery stores. The application downloads the floor plans and inventory of the grocery store where the user is located, displaying the floor plans on the display of the user's device, and manually or automatically retrieves the locations of the user's items for purchase from the user's grocery list, calculating the cumulative cost of items on the grocery list. Locations of the items on store shelves are highlighted on three-dimensional color displays, and the shortest route to all desired items in the store is calculated using an algorithm. The application exchanges information with support staff, enabling assistance in a timely manner.

### REFERENCE TO RELATED APPLICATION

This non-provisional patent application claims the benefit of provisional application Ser. No. 62/203,491 filed on Aug. 11, 2015, titled Mobile Application For Full-Service

Grocery Shopping, which is incorporated herein in its entirety.

### BACKGROUND OF THE INVENTION

The invention relates generally to mobile applications and, more particularly, to a mobile application and system for full-service grocery shopping. Just as self-service filling stations of the past have left certain customers wishing for full service, changes in the grocery shopping experience have left many customers wishing for more assistance from the store staff. Unfortunately, many customers are elderly or disabled and, with the trend toward larger and larger grocery stores, hiking all over the store to shop for a week's worth of groceries can wear out these customers. Shopping should be a pleasant experience, not a test of physical endurance. Existing mobile applications enable efficient shopping, but do not enable interaction with store staff. A mobile application for full-service grocery shopping, which shows a customer where items on the grocery list are located and provides instant communication with key members of the store staff, enabling timely services such as valet parking service, would resolve this problem.

### SUMMARY OF THE INVENTION

Accordingly, a real-time full-service shopping system according to the present invention is directed to a software application running on a mobile computing device, e.g. a smartphone, tablet, or the like, for full-service grocery shopping. The mobile application may be downloaded on the user's smart phone, tablet, or other mobile electronic device, enabling the user to subscribe to a shopping support service or participant network, and provides access to an online database of detailed floor plans and inventories of participating stores in every major metropolitan area of the United States. The application downloads the floor plans and inventory of the grocery store where the user is located, displaying the floor plans on the visual display of the user's device, and may be used to manually or automatically retrieve the locations of the user's desired items for purchase from the user's grocery list, and calculating the cumulative cost of all items on the grocery list. Locations of the desired items on store shelves are highlighted on three-dimensional color displays, and the shortest route to all desired items in the store is calculated using an algorithm. The generated suggested route may be displayed on the mobile computing device that is running the software application. The application also exchanges information with key support staff, such as the checkout lane staff and valet parking staff, enabling assistance in a timely manner.

Therefore, a general object of the present invention is to provide a system and method for shopping that guides customers while they are shopping in a store by providing real time store layout data, product location data, and the like.

Another object of the present invention is to provide a system and method for shopping, as aforesaid, in which a user selects a store using the mobile application and, when present at the store and uploads a shopping list, the store layout, product locations, and a suggested and preferred route for shopping are displayed via the application on the user's mobile device.

Still another object of the present invention is to provide a system and method for shopping, as aforesaid, in which other features for full-service shopping are provided, such as valet parking, communication with checkout staff, real-time totals of items purchased, and the like.

Other objects and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

FIG. 1 is block diagram illustrating a system and method for real-time full service shopping;

FIG. 2 is a symbolic representation of “marker data” that is used when generating a suggested route for traversing a store while shopping.;

FIG. 3 is a block diagram of an indoor positioning system according to an embodiment of the present invention;

FIG. 4 is a block diagram of a store data system according to the present invention;

FIG. 5 is a block diagram of a software application running on a mobile computing device according to the present invention;

FIG. 6 is a block diagram of a remote computing system according to the present invention; and

FIG. 7 is a flowchart illustrating an exemplary embodiment of the method for real-time full service shopping.

### DETAILED DESCRIPTION OF THE INVENTION

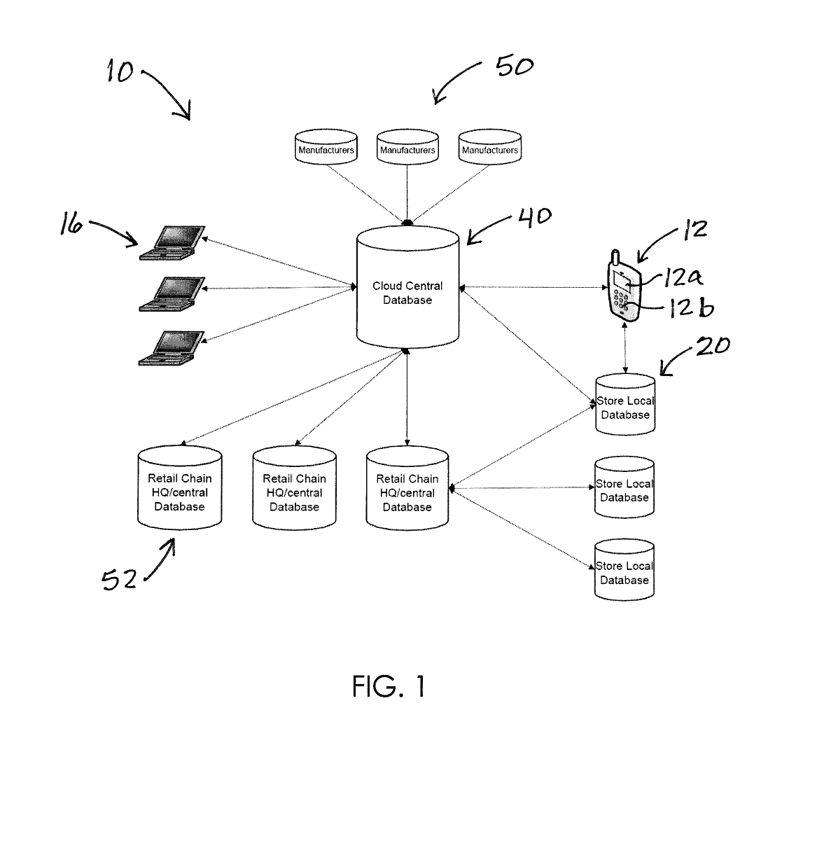

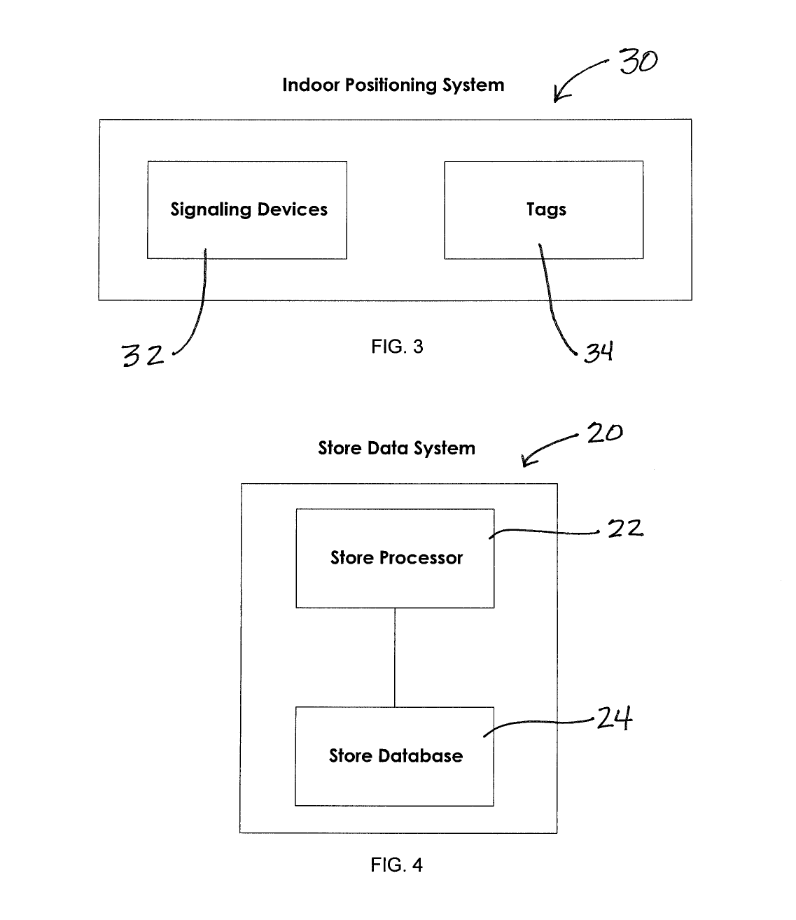

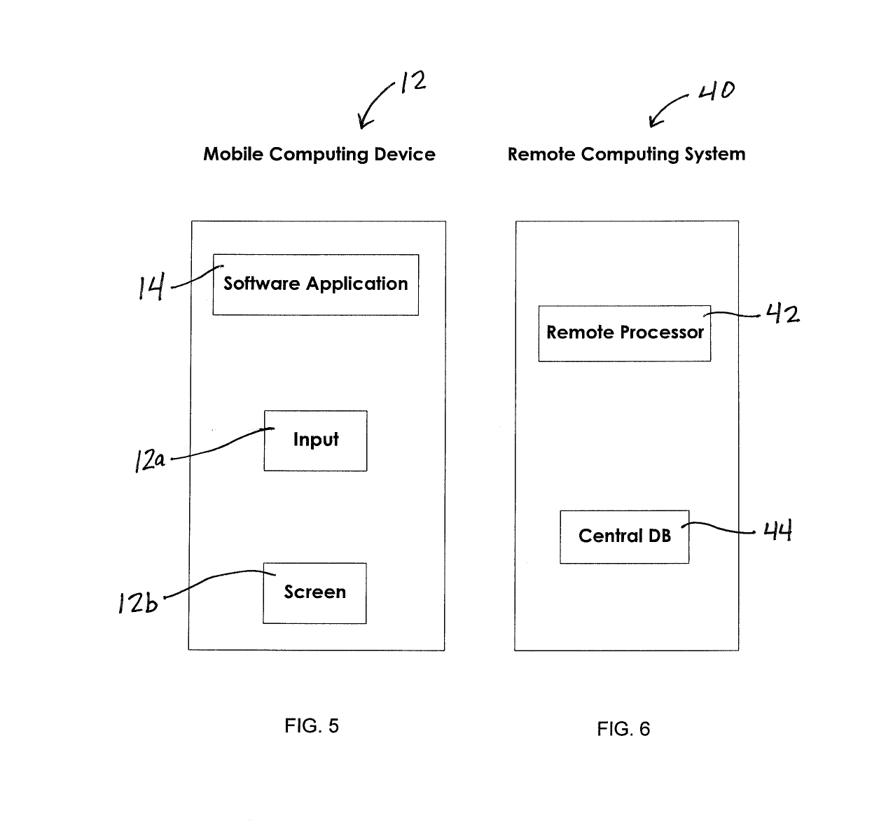

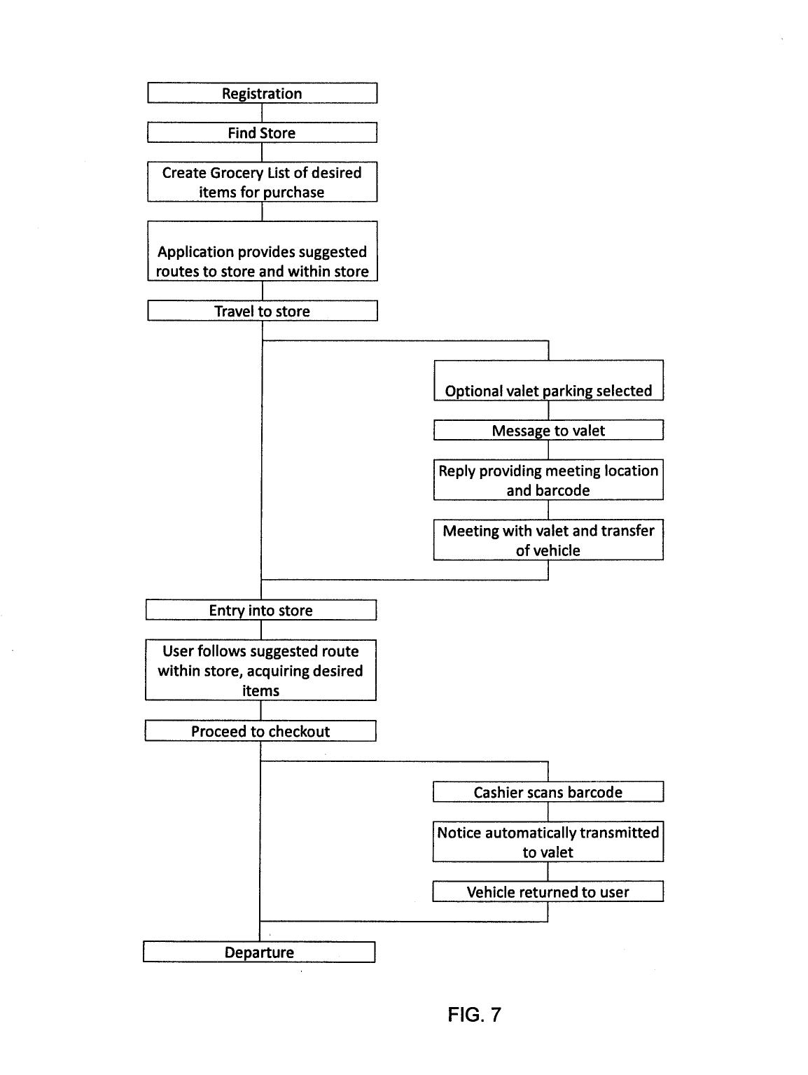

A method and system for shopping with real-time store layout, item location, and full service shopping assistance will be described with reference to FIGS. 1 to 7 of the accompanying drawings. The method and system 10 includes a plurality of store data systems 20, a software application 14 (also referred to as a mobile app) running on a mobile computing device 12, and a remote computing device 40 (also referred to as a “Central Database”).

It is to be understood that while the invention is described in use with grocery store items, this is not intended as a limitation. With or without modification, the invention may be used with items to be purchased in any type of store maintaining a computerized inventory, such as a department store, a home improvement store, a general retail store, or the like.

The system 10 may include a plurality of store data systems 20, each one representing a store that participates in the shopping network, i.e. a participating store. Each store data system 20 may include a computer server having a store processor 22 and a store database 24 (including a non-volatile store memory). The store database 24 includes data structures configured to receive and store inventory data, store layout data (i.e. the layout of fixtures, aisles, building infrastructure, etc), and product location data (i.e. a specific aisle and shelf position of where each product is located).

Each store data system 20 may include an indoor positioning system (IPS) 30 that is configured to determine the location and movement of a plurality of tags in a predefined area, such as the area defined by the walls of a store. A plurality of signaling devices 32 may be distributed throughout the predefined area that, together, can triangulate or otherwise communicate with respective tags 34 in a manner configured to determine the location of the tags. This data, in cooperation with store layout data and a shopping list submitted by a user will enable the store processor 22 to determine a preferred or suggested route for a user to traverse to most efficiently find respective shopping list products to be purchased.

More particularly, the plurality of tags 34 may include user tags associated with actual shoppers so that their physical presence and location in the store may be tracked. Each user tag may be in the form of an electronic token that may be carried by a user, such as in a pocket, on a key ring, or attached to a mobile phone or the like. Product tags may be electronic tokens, transmitters, bar codes, radio frequency identification tags (RFID), or the like.

When a user selects a participating store in which to shop, prepares and communicates a shopping list to the store, and physically enters the store's defined area, the IPS 30 within the store will be able to track the user's movement and to communicate a suggested route, product positions, etc. When the user is in proximity to the store (or actually inside), he may use the software application 14 to cause the mobile computing device 12 to send a signal—e.g. a cellular signal, a transmitter/receiver component, radio frequency, bar code, etc.—to an electronic “access point” at the store location, whereby to use his authentication information to gain access. Then, a shopping list of desired goods may be created by the software application 12 using the input 12a of the mobile computing device 12 and uploaded. The store database 24, under program control, may then generate a map including a suggested route through the store layout for retrieving the selected items. The map with suggested route may be communicated to the application for display on a screen 12b of the mobile computing device 12, including store layout, product position, and the user's position—all generated by the respective IPS of the selected store data system 20.

In an embodiment, the store layout data, product position data, product inventory and price data may be uploaded to the software application when a user has selected a store location at which to shop. Then, the application 14 is programmed to utilize the uploaded data to generate the suggested route and display it on the display of the mobile computing device 12. Updates on the user's location, products procured, revised shopping list, etc. may be communicated to the application and new maps generated by the application.

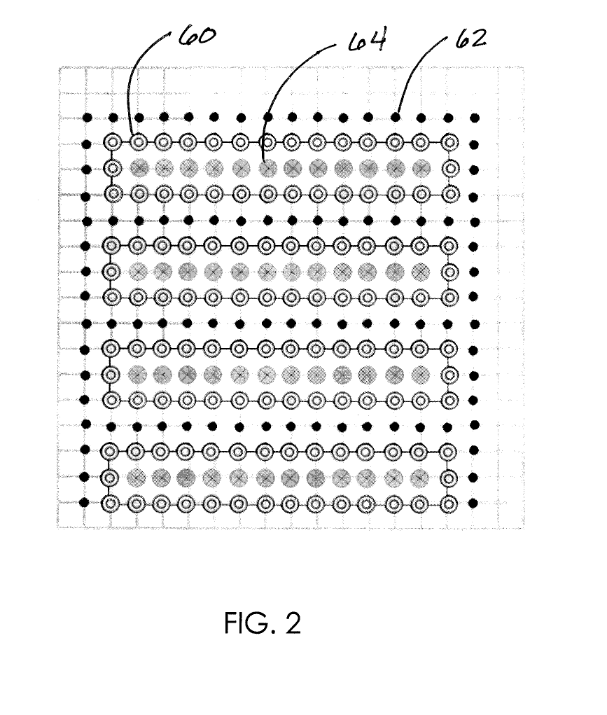

Now with further reference to how to how a suggested and preferred shopping route is generated, the store layout data may include “marker data” (FIG. 2) that is indicative of (1) where a user is permitted to walk (e.g. aisles and public areas) referred to as an “inactive point” 62 (2) where a user would be not be permitted or able to walk (e.g. product shelving fixtures, point of sale areas, infrastructure like walls, posts, mechanical equipment, and the like) referred to as an “dormant point” 64 (labeled as “x”), and (3) product areas referred to as “active point” 60. Thus, a store processor 22 or application 14 seeking to choose the most efficient route between a user's current position and a selected product is not able to just go “as the crow flies” but must use only permitted positions to be selected, i.e. aisles.

The store processor 22, in cooperation with the respective IPS 30, is able to track user movement, product movement, and can detect when a user has procured an item in that the location of the user and product will significantly the same. The grocery list can be updated to indicate the procured item is no longer on the list to be procured. The store processor 22 is further configured to update the user position and next product to be located and an updated map of the suggested route communicated to the software application on the mobile computing device 12.

In another aspect, the system 10 may include a remote computing device 40, such as a cloud-based server (FIG. 1), that is in data communication via the internet with each participating store data system 20. The remote computing device 40 may include a remote processor 42, a remote memory (in the form of a central database 44), and means for connecting to the internet for connecting to mobile computing devices 12 by cellular telephone signals, and the like.

A user may initially communicate with the remote computing device 40 (central database) so as to register as an authorized user of the system 10. The user may connect to the remote computing device 40 using a laptop or desktop computer 16 via the internet so as to sign up or by means of the mobile computing device 12 utilizing the appropriately configured software application 14. A username, login, email address, and other personal information may be entered and recorded. It is understood that registered user data may be communicated from the remote computing device 40 to each of the store data systems 20 that may later be selected by the user for shopping. The remote computing device 40 may include programming that, when executed by the store processor 22, communicates with the plurality of store data systems 20 so as to receive and store each store's inventory data, store layout data, and other useful data. In addition (or in the alternative), the remote computing device 40 may have authority or be granted permission to access on demand, the data stored in each store database.

In an embodiment, the store data systems 20 are configured, such as by programming, to track multiple aspects of the shopping actions of shoppers and may communicate that data to the remote computing device 40. More particularly, the indoor positioning system 30 (IPS) in operation by each store data system 20 collects data regarding detected movements of a user tag or product tag, an amount of time a user is shopping in the store, items selected for purchase, location of the item purchased, and the like. Each store data system 20 is configured to communicate this collected information to the remote computing device 40 (i.e. central database) where it may be used for future marketing, advertising, metric analysis, decisions regarding future placement of products, or other reasons.

In another aspect of the invention, the remote computing device 40 may be in data communication, such as via the internet, with one or more manufacturer databases 50 associated with manufacturers of products carried by respective store data systems 20. The remote computing device 40 may be configured to store vast inventories of products available from the manufacturers even if respective store data systems 20 choose to carry only a portion of the products in their stores.

Similarly, the remote computing device 40 may be in data communication, such as via the internet, with retail and chain shopping stores 52 in substantially the same manner as described above relative the plurality of store data systems 20. In other words, the chain shopping stores 52 may be networks of the same type of store, combination, grocery/general retail, or the like.

Now, use of the mobile software application, operation of the store data systems (i.e. local stores available for shopping) will be discussed to fully appreciate and understand the technical details of the system given above. The first exemplary embodiment is comprised of a mobile application 14 (a “mobile app” or “software app”) which may be downloaded on the user's smart phone, tablet, or other mobile electronic device, enabling the user to subscribe to a shopping support service. The subscription is preferably available at two levels: a standard subscription and a premium subscription which provides additional features. The application also provides access to an online database of detailed inventories and floor plans of grocery stores in every major metropolitan area of the United States, which is operated by the managing entity of the application. The managing entity acquires and updates floor plans and inventories of all grocery stores in the database from information acquired from the corporations which own or manage the grocery stores.

After downloading the application, the user must register a username, password, and e-mail address. Registration may be accomplished directly from the mobile app 14 or via an internet connection from a computer 16. The user begins by selecting the Find Store function and may elect to limit the search by entering a desired store brand name, such as Target, Wal-Mart, or Safeway. Options to Go Back or Proceed are provided. All searchable brand names options are based on those companies electing to use the managing entity's cloud data storage (i.e. the remote computing device). The user may then enter city and state or zip code. An option to Go Back is provided.

The subsequent search is similar to any Global Positioning System (GPS) device search to find locations of chosen preference in the closest location. The user's visual display shows the closest locations, providing store brands, store codes, and store addresses. Options to Go Back or start over from Find Store are provided. The user then selects a store within the closest location of the desired store brand name or preferred location to shop.

When the user is in a predetermined proximity to the selected store, he may create a shopping list of desired products he wishes to purchase at the store. Using the application 14, he may upload the shopping list to the selected store where it will then be processed and a preferred or suggested route of travel throughout the store will be generated and communicated back to the mobile app, as will be discussed further later. The application 14 may include a Transfer List feature that enables a user to access a previously used list with the selected store. The application also enables the user to search for a single item and have its location identified on the display of the mobile computing device.

The Find Store function shows the selected store information, displaying the store identification number code, address, store hours, amount of registers open, and three estimated levels listed by level and traffic light coloring. Options to Go Back or Select Store are provided. Prices are generated from store selection and the user's Grocery List.

The application downloads the floor plans and inventory of the grocery store which the user has selected, displaying the floor plans on the visual display of the user's device, and may be used to manually or automatically retrieve the locations of the user's desired items for purchase from the user's grocery list, calculating the cumulative cost of all items on the grocery list.

The floor plan is displayed in a color-coded “planogram view.” Locations of the desired items on store shelves may be highlighted on three-dimensional color displays, and the shortest route to all desired items in the store is calculated using an algorithm. Shelves are highlighted in multiple colors on the visual display, with the location of the desired item displayed with greater brightness, and other sections of the shelves grayed out.

The homepage version of the application may reappear, displaying the identified user, and the store code and address. The user has the option to sign out or remove the store code to return to previous screen. Find Store, List Transfer, Find an Item, and Go Shopping will be active options. Selecting Find Store allows the user to restart at the Find Store feature. List Transfer is to access a received a saved grocery list or single desired item. Find an Item is the option to be used when selecting one desired item. Action “search widget” appears to type and search desired like item.

Go Shopping is the option to search all like items to create a Shopping Cart. When Go Shopping is activated, options to Quit and Save, view the Shopping Cart, go to Next Item upon selection, and Checkout are provided. Shopping Cart lists the items selected and provides the options to Remove Item, Add Item, go Back to Shopping, or Checkout. When the user selects a desired item, the Back to Shopping and Checkout button features turn into Change Amount and Delete button features.

The user then completes and saves the shopping/grocery list. A new Save Screen option appears that generates and saves the grocery list based on the prices and location selected. The created grocery list is automatically stored under the List Transfer option available on the homepage. The Shopping Cart appears, displaying sales price, taxes, and total price after checkout.

The user may be provided four options: Start Shopping, Exit Shopping, List Transfer, and Edit List. Once the user has completed the Find Item or Go Shopping function, the floor plan of the grocery store is displayed with the suggested route and upon arrival, the user may proceed with acquiring selected items.

As the user proceeds through the grocery store to acquire a desired item, the application may display suggested additional items which are frequently purchased by other persons who purchase the same selected item as the user. The application may also list customer preferred ratings of similar items if the purchasing consumer wishes to know a preferred or popular item, and is capable of operating from the user's prior buying habits as indicated by previous grocery lists. Shopping for complementary brands and like items will also be displayed under the selected item to influence customer purchasing. Each of these features may be blocked at the user's discretion.

The application also exchanges information with key support staff, such as the checkout lane staff and valet parking staff, enabling assistance in a timely manner. When the user is driving to the grocery store, the application may be used to send a message to the valet parking staff. A reply may be sent to the user, which indicates the lane or other location where the user may meet a parking valet. The application also generates barcodes which may be scanned by the checkout lane staff and valet parking staff, for the purpose of expediting service.

The homepage of the application provides a plurality of clickable buttons on the visual display of the user's mobile electronic device. The Grocery List button opens the Grocery List page, which is a form that may be populated by the user, listing the names and desired quantities of grocery items needed. The categories button provides a list of categories of items sold in the selected grocery store, such as bakery goods, canned goods, and fresh produce, enabling the user to browse through the categories when preparing the grocery list. The inventory button provides the user access to the inventory list stored in the database. The sales button provides the user access to a list of discounted items available at the selected grocery store.

A portion of each list of data acquired by the application is provided in the display area on the homepage, enabling the user to review the list by scrolling up or down. A search button is provided, enabling the user to search each list for specific desired items or categories. The user may also view the entire list by double clicking on the corresponding button.

The application downloads the floor plans and inventory of the grocery store where the user is located, displaying the floor plans on the visual display of the user's device, and may be used to manually or automatically retrieve the locations of the user's desired items for purchase from the user's grocery list, calculating the cumulative cost of all items on the grocery list.

The grocery list page displays the grocery list prepared by the user, with discounted items highlighted in a bright color, such as red. The grocery list page self-populates with the aisle number where each item on the grocery list is located. The grocery list page then calculates the cumulative cost of all items on the grocery list, as well as the estimated shopping time, based on distances between selected grocery items on the floor plan and a slow walking pace of 1.5 miles per hour.

Such government programs as Women, Infants and Children (WIC) and Electronic Benefits Transfer (EST) are more easily administered and used with the application. Approved items for purchase under these programs are displayed on the user's mobile electronic device and may be provided by appropriate agencies to the managing entity. Methods of payment accommodated include debit cards and direct transfer of funds from the user's checking account. If the user is utilizing a government program such as WIC or EBT, notices are provided when the user selects an item which is ineligible for purchase under the government program.

When the user has finished shopping and is ready to check out, an estimated checkout time is provided, based on the items selected and the number of cashiers on duty. Upon reaching a checkout lane, the user may provide the barcode for the cashier to scan. This scan automatically causes a message to be sent to the valet parking staff, indicating that the user is checking out and that the user's vehicle should be retrieved. The user selects a method of payment, such as a debit card or direct transfer of funds from the user's checking account.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. A system of shopping in real-time for guiding a customer to customer-selected products based on a real-time position of the customer and the real-time layout of a store, said shopping system, comprising:
a plurality of store data systems distributed throughout a wide geographic area and indicative of participating stores, each store data system having a store processor and a store database in data communication with said store processor that is configured to include store inventory data, real-time grid-based store layout data, and real-time product location data associated with said store layout data;
a software application running on a mobile computing device that is configured for communicating with respective store data systems;
wherein said application is programmed to:
receive shopping list data from a user via an input member of said mobile computing device;
receive store selection data from a user via the input member of said mobile computing device indicative of a selected store in which to shop;
transmit said shopping list data and said store selection data to said selected store data system when said mobile computing device is in proximity to said selected store;
wherein said selected store system is programmed to:
receive said shopping list data and said store selection data from said application;
determine a suggested shopping route through said selected store based on said store layout data associated with said selected store, said item location data associated with said selected store, and said received shopping list data;
generate a grid-like graphical map according to respective store layout data associated with said selected store and said suggested route;
deliver said generated map to said application for display by the mobile computing device;
wherein said application is programmed to receive said generated map indicative of said suggested route from said selected store database and to display said generated map on an output screen of the mobile computing device.

2. The real-time shopping system as in claim 1, wherein:
said plurality of store data systems include an indoor position system (IPS) in communication with a respective store processor and configured to track a real-time position of a plurality of tags in a predefined area associated with a respective store;
said plurality of tags includes:
a user tag that is recognized by a respective IPS as associated with an associated user being present in said respective store;
a plurality of product tags recognized by said respective IPS as associated with products located in said predefined area according to respective store layout data;
said IPS includes a plurality of signaling devices distributed over said predefined area configured to determine a real-time position of said plurality of tags.

3. The real-time shopping system as in claim 2, wherein a respective IPS in communication with said respective store processor is configured to:
detect real-time movement of said user tag;
detect real-time movement of a respective product tag;
determine that a respective user has procured a respective product based on a matching of a location of said user tag and respective product tag having a substantially similar location.

4. The real-time shopping system as in claim 3, wherein said respective store processor is configured to update said shopping list data when said respective IPS and said respective store processor determines that a particular product associated with said shopping list data has been procured.

5. The real-time shopping system as in claim 3, wherein:
said respective store layout data includes marker data indicative of where a user is permitted to traverse and where a user is not permitted to traverse due to fixture, infrastructure, or product placement;
said respective store processor is configured to determine said suggested route in view of said respective marker data.

6. The real-time shopping system as in claim 3, wherein said selected store system is programmed to:
update said generated map and suggested route according to detected movement of the user by said respective IPS;
communicate said updated map to said application for display by the mobile computing device.

7. The real-time shopping system as in claim 1, further comprising:
a remote computing device accessible via a wide area network that includes a shopping management database stored in a non-volatile remote memory having data structures and programming and a remote processor in communication with said remote memory that is configured to selectively execute said programming;
wherein said remote computing device is configured to one of 1) receive and store in said remote memory respective data from each store database or 2) be granted internet access on demand to respective data from each store database.

8. The real-time shopping system as in claim 7, wherein said remote computing device is programmed to:
receive registration data of a user via an internet connection;
communicate said registration data to said plurality of store data systems so that a shopping interaction between a respective application associated with a respective registered user is authenticated.

9. The real-time shopping system as in claim 3, wherein a respective store data system associated with said selected store is configured to:
collect shopping data associated with at least one of a respective user identity, said detected movements of a user in said predefined area, detected product procurement, respective item locations of procured products;
communicate said collected shopping data to said remote computing device.

10. The real-time shopping system as in claim 7, wherein said remote computing device is in data communication via the internet to product manufacturer database system associated with respective store inventories of respective store databases.

11. A method for real-time shopping for guiding a customer to customer-selected products based on a real-time position of the customer and the real-time layout of a store, said method, comprising:
providing a plurality of store data systems distributed throughout a wide geographic area and indicative of participating stores, each store data system having a store processor and a store database in data communication with said store processor that is configured to include store inventory data, real-time grid-based store layout data, and real-time product location data associated with said store layout data;
running a software application on a mobile computing device that is configured for communicating with respective store data systems;
said application receiving shopping list data from a user via an input member of said mobile computing device;
said application receive store selection data from a user via the input member of said mobile computing device indicative of a selected store in which to shop;
said application transmitting said shopping list data and said store selection data to said selected store data system when said mobile computing device is in proximity to said selected store;
said selected store data system receiving said shopping list data and said store selection data from said application;
said selected store data system determining a suggested shopping route through said selected store based on said store layout data associated with said selected store, said item location data associated with said selected store, and said received shopping list data;
said selected store data system generating a grid-like graphical map according to respective store layout data associated with said selected store and said suggested route;
said selected store data system delivering said generated map to said application for display by the mobile computing device;
said application receiving said generated map indicative of said suggested route from said selected store database and displaying said generated map on an output screen of the mobile computing device.

12. The real-time shopping system as in claim 11, comprising:
tracking a real-time position of a plurality of tags in a predefined area associated with a respective store data system via an indoor position system (IPS) in communication with a respective store processor;
wherein said plurality of tags includes:
a user tag that is recognized by a respective IPS as associated with an associated user being present in said respective store;
a plurality of product tags recognized by said respective IPS as associated with products located in said predefined area according to respective store layout data;
wherein said IPS includes a plurality of signaling devices distributed over said predefined area configured to determine a real-time position of said plurality of tags.

13. The real-time shopping system as in claim 12, further comprising:
wherein a respective IPS in communication with said respective store processor is configured to:
a respective IPS detecting real-time movement of said user tag;
a respective IPS detect real-time movement of a respective product tag;
a respective store processor determining that a respective user has procured a respective product based on a matching of a location of said user tag and said respective product tag having a substantially similar location.

14. The real-time shopping system as in claim 13, further comprising updating said shopping list data when said respective IPS and said respective store processor determines that a particular product associated with said shopping list data has been procured.

15. The real-time shopping system as in claim 13, wherein:
said respective store layout data includes marker data indicative of where a user is permitted to traverse and where a user is not permitted to traverse due to fixture, infrastructure, or product placement;
said respective store processor is configured to determine said suggested route in view of said respective marker data.

16. The real-time shopping system as in claim 13, further comprising:
said selected store system updating said generated map and suggested route according to detected movement of the user by said respective IPS;
said selected store system communicating said updated map to said application for display by the mobile computing device.

17. The real-time shopping system as in claim 11, further comprising:
providing a remote computing device accessible via a wide area network that includes a shopping management database stored in a non-volatile remote memory having data structures and programming and a remote processor in communication with said remote memory that is configured to selectively execute said programming;
said remote computing device one of 1) receiving and storing in said remote memory respective data from each store database or 2) being granted internet access on demand to respective data from each store database.

18. The real-time shopping system as in claim 17, further comprising:
said remote computer receiving registration data of a user via an internet connection;
said selected store system communicating said registration data to said plurality of store data systems so that a shopping interaction between a respective application associated with a respective registered user is capable of being authenticated.

19. The real-time shopping system as in claim 13, wherein associated with said selected store is configured to:
a respective store data system collecting shopping data taken from a group consisting of a respective user identity, said detected movements of a user in said predefined area, detected product procurement, time spent in a respective store, and respective item locations of procured products;
a respective store data system communicating said collected shopping data to said remote computing device.

20. The real-time shopping system as in claim 17, wherein said remote computing device is in data communication via the internet to at least one product manufacturer database system associated with respective store inventories of respective store databases.
